(19) United States
(12) Patent Application Publication
(10) Pub. No.: US 2018/0235142 A1
(43) Pub. Date: Aug. 23, 2018

(54) SPREADER

(71) Applicant: Juergen SCHOELS, Hoetzeldorf (AU)

(72) Inventor: Juergen SCHOELS, Hoetzeldorf (AU)

(21) Appl. No.: 15/752,604

(22) PCT Filed: Aug. 12, 2016
(86) PCT No.: PCT/EP2016/069272

§ 371 Date: Mar. 1, 2018

(30) Foreign Application Priority Data
Aug. 14, 2015 (AT) GM50161/2015

(51) Int. Cl. A01C 17/00; A01C 7/10; A01C 7/08

(52) U.S. Cl. CPC A01C 17/001; A01C 7/085; A01C 17/008; A01C 7/107

(57) ABSTRACT

The invention relates to a disc spreader comprising a frame consisting of a base frame (11) and an auxiliary frame (21), wherein a container (61) is secured to the base frame (11) and a spreader disc (22) is secured under the container (61) on the auxiliary frame (21), wherein, according to the invention, a dosing unit (12), preferably having a cellular wheel sluice (18), is arranged on the base frame (11) under the container (61), said dosing unit having an outlet (14) at the bottom for a collection hopper (23), wherein the collection hopper (23) is secured to this outlet (14) of the dosing unit (12) and the auxiliary frame (21) is secured on the base frame (11) by means of a quick-closure (15, 25). In this way, it is possible to provide a distributer (32, 32a) which can be connected to the outlet (14) of the dosing unit (12) after removal of the auxiliary frame (21) and the collection hopper (23), such that the disc spreader can be converted into a seeder.

### TECHNICAL FIELD

The present invention relates to a spreader comprising a frame consisting of a base frame and an auxiliary frame, with a container being secured to the base frame and a spreader disk being secured beneath the container to the auxiliary frame.

### PRIOR ART

Disk spreaders with a frame to which a container is secured and to which a collection hopper and a spreader disk are secured beneath the container are known and used to distribute seeds, for example. These are generally small spreaders in which the container holds 40 L or 100 L of seed, for example. An adjustable opening is located beneath the container so that the spread rate can be adjusted. The collection hopper, which delivers the seed to a point of the spreader disk from which the seed is distributed by (usually two) thrower blades, is then located below that. The spread width can be adjusted by changing the speed of the spreader disk.

A spreader of the type mentioned at the outset is known from DE 3331169 or also DE 2818227. In the spreader according to DE 3331169, a centrifugal disk with a drive is provided beneath the container, with the drive being mounted together with the centrifugal disk on a rocker frame pivotally mounted to the frame. If the rocker frame is pivoted down, the centrifugal disk can be removed from the output shaft of the drive device. The entire rocker frame can also be easily detached from the frame, which not only facilitates repairs but also enables different drives to be used for different speeds.

So-called pneumatic seed drills are also known with which seed is also put simultaneously in the ground. In these devices, a cell-wheel sluice is provided beneath the container in order to ensure exact metering. A distributor is located beneath the cell-wheel sluice. The individual cells of the cell-wheel sluice each meter flow in their own respective subregion of the distributor. Depending on the design of the cell-wheel sluice and distributor, different numbers of partial flows result—such as for example 2, 4, or 6. The cell-wheel sluice ensures that the partial flows are relatively constant and of relatively exactly the same size. Hoses (e.g., 2, 4, or 6 hoses) lead from the distributor to baffle plates where the seed strikes and is distributed.

If seed is also applied at the same time as the ground is worked, it is better to use a seed drill, because it distributes the seed more uniformly in comparison to disk spreaders, being particularly less influenced by wind.

The additional costs are disadvantageous especially for small operations, since a disk spreader is generally already on hand. For this reason, disk spreaders are often used when seed is to be applied when also working the soil. As a result, however, the seed is applied such that it is not distributed in a sufficiently precise manner in most cases, which leads to a reduction in yield and/or to an unnecessarily large sowing quantity.

### DESCRIPTION OF THE INVENTION

It is the object of the present invention to provide a remedy in this respect.

According to the present invention, provision is thus made in a spreader of the above-mentioned type that a metering unit, preferably with a cell-wheel sluice having an outlet at the bottom for a collection hopper, is mounted on the base frame beneath the container, that the collection hopper is secured to this outlet of the metering unit, and that the auxiliary frame is secured to the base frame by a quick-action fastener. The provision of the metering unit enables the disk spreader to be easily modified such that it can also be used for a seed drill. An additional advantage is that very precise metering is also achieved when functioning as a disk spreader by virtue of the metering unit. Besides the exact metering, it is also possible to regulate the application rate in a speed-dependent manner.

The speed of the cell-wheel sluice is regulated electronically as a function of the tractor-travel speed such that the applied quantity of seed per unit area is always maintained constant. While it is true that the device is rendered somewhat more expensive as a result, this is more than compensated for by the advantage that it can be converted for use with a seed drill, thereby saving the costs associated with an additional device. Furthermore, seed whose cost increases quickly can also be saved by virtue of the precise application.

Preferably, the auxiliary frame is mounted on the base frame so as to pivot about an axle so that it can be pivoted down and out of the way after release by the quick-action fastener. It is thus very simple to check and adjust the metered quantity. The spreader disk can thus be folded away and the quantity delivered by the metering unit can be caught in a container held below same and then weighed. In order to set the metered quantity exactly in conventional disk spreaders, it is necessary to carry out the calibration procedure at the disk speed that is actually set during work, because, as a result of the air turbulence of the spreader disk and the suction effect associated therewith, the throughput in kg/min is also directly dependent on the disk speed. The quantity scattered by the spreader disk has to be “caught,” that is a container (such as a sack) must be positioned around the spreader disk and sealed to some extent, which is substantially more inconvenient. As a result of the active metering of the seed in the present invention, there is no suction effect on the seed. The calibration process can therefore be carried out when the spreader disk is idle (folded away), which is both easier and safer. Moreover, unlike with conventional disk spreaders, there is no change in the flow rate in kg/min if the working width and thus the spreader disk speed changes.

As mentioned above, it is an advantage of the disk spreader according to the invention that it can be converted for a seed drill. It is therefore an additional object of the invention (in the manner of a “kit of parts”) that a distributor is provided that can be connected to the outlet of the metering unit upon removal of the auxiliary frame and collection hopper. The auxiliary frame with the spreader disk and the collection hopper are removed in this application.

The distributor is preferably provided with a blower. This ensures reliable conveyance of the seed through the connected hose lines. Particularly with smaller seed drills, however, conveyance by gravity alone can be sufficient. The blower can then be omitted.

### BRIEF DESCRIPTION OF THE DRAWING

The present invention will be explained in further detail with reference to the attached drawings in which:

FIG. 1 shows a base frame with removed container;

FIG. 2 shows an auxiliary frame with spreader disk;

FIG. 3 shows a distributor;

FIG. 4 shows another distributor;

FIG. 5 shows a blower that can be combined with the distributors of FIGS. 3 and 4;

FIG. 6 shows a container for attachment to the base frame of FIG. 1;

FIG. 7 shows a disk spreader formed by the components of FIGS. 1, 2, and 6;

FIG. 8 is a section through this disk spreader;

FIG. 9 is a section through a spreader formed the components of FIGS. 1, 3, and 6; and

FIG. 10 shows a spreader formed of the components of FIGS. 1, 3, 5, and 6.

### MANNER(S) OF CARRYING OUT THE INVENTION

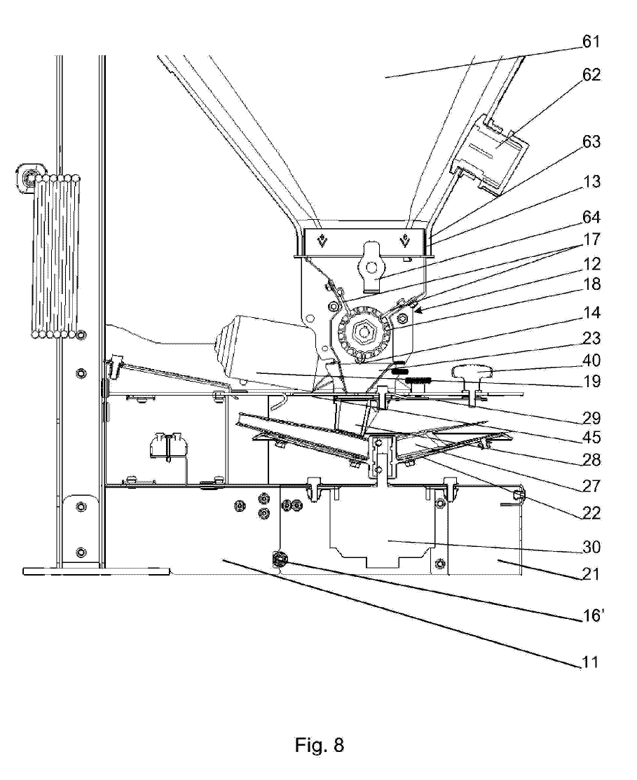

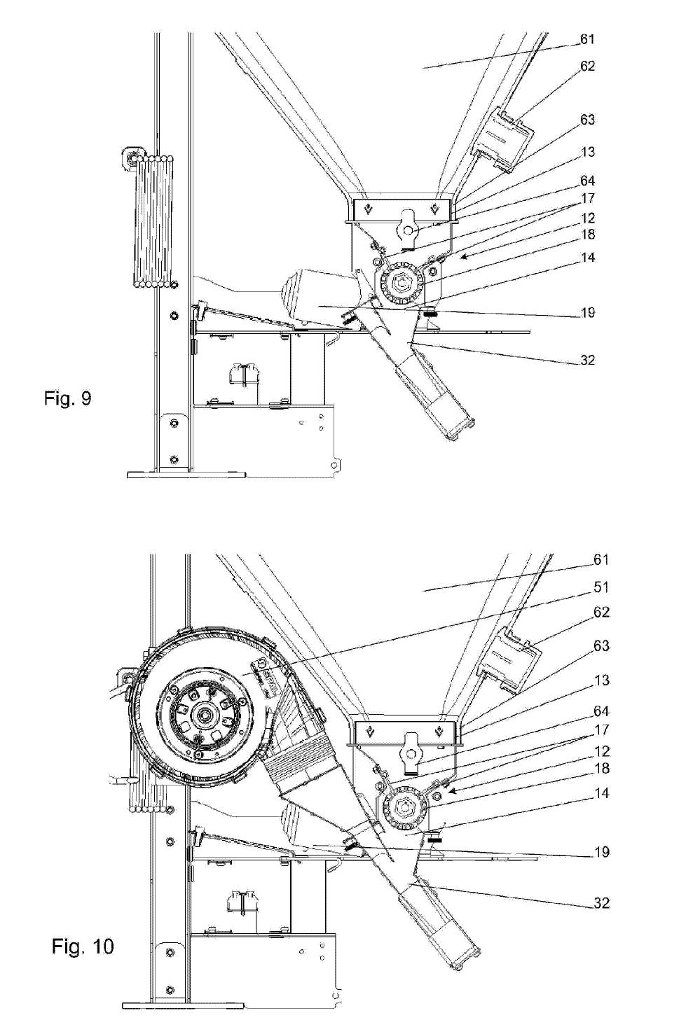

FIG. 1 shows a metering unit 12 secured to a base frame 11. As can be seen from FIG. 8, the metering unit 12 consists substantially of a cell-wheel sluice 18 whose cells are each capable of holding a predetermined volume of seed. With each revolution of the cell wheel, a quantity of seed corresponding to this volume multiplied by the number of cells is conveyed through. Two scraper brushes 17 are provided to prevent seed from passing by the cell wheels without having been actively metered. The cell-wheel sluice 18 is driven by a gear motor 19; by changing the speed of the gear motor 19, the flow rate through the cell-wheel sluice 18 can be adjusted.

The metering unit 12 has an upper connector 13 (see also FIG. 1) for a container 61 (see also FIG. 6). The container 61, in turn, has a connection 63 that fits with the connector 13 (see FIG. 8). In this way, containers with different capacities can be mounted on the base frame 11. As usual, the container 61 has a emptying port 62.

To ensure that the material in the container 61 is fed reliably in the metering unit 12, an agitator 64 is provided above the metering unit 12.

The metering unit 12 has an outlet 14 through which the metered material travels. The outlet 14 has a flange 14′ (see FIG. 1) with threaded bolts to which hand nuts 36 are screwed.

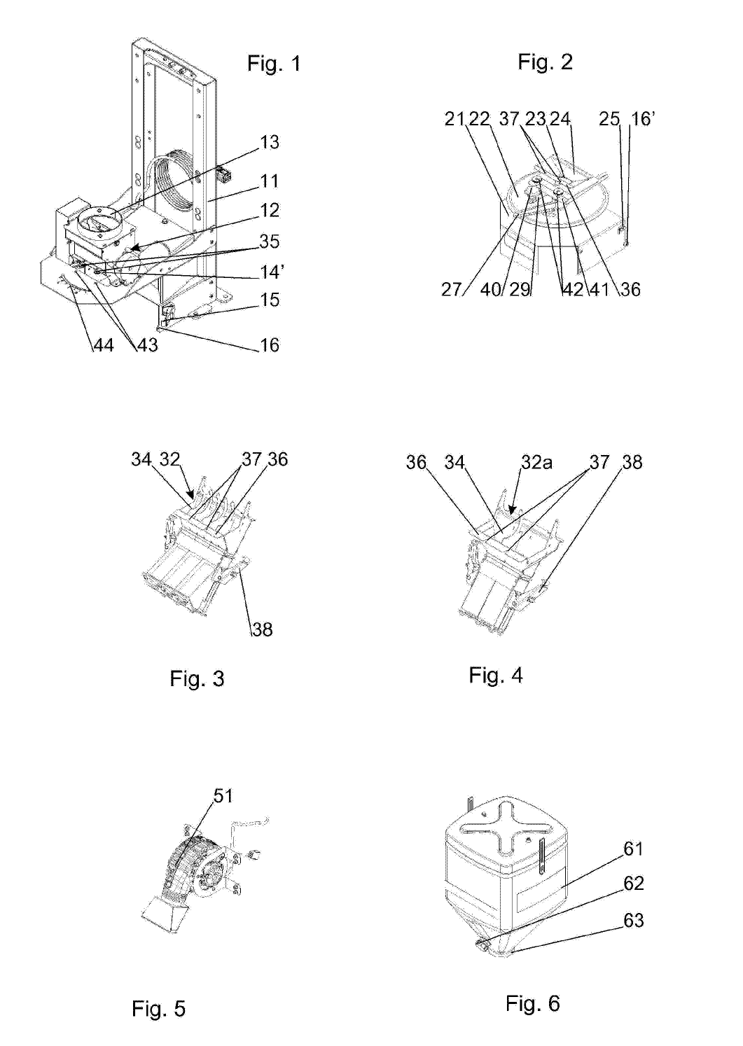

According to the invention, an auxiliary frame 21 (see FIG. 2) can be connected to the base frame 11. For this purpose, the base frame 11 (see FIG. 1) has a quick-action fastener 15 that cooperates with a mating part 25 (see FIG. 2) on the auxiliary frame 21. The auxiliary frame 21 can thus be dismounted very quickly.

A spreader disk 22 with thrower blades 27 is mounted on the auxiliary frame 21. The spreader disk 22 is driven together with the thrower blades 27 by a motor 30 (see FIG. 8). By changing the speed of the motor 30, the throw width changes.

To ensure that the material is deposited at a specific location on the spreader disk 22, a collection hopper 23 is provided. The upper opening 24 (see FIG. 2) of the collection hopper 23 is adapted to the outlet 14 (see FIG. 8) of the cell-wheel sluice 18. The opening 24 (see FIG. 2) has a flange 36 having two slots 37. The collection hopper 23 can thus be pushed with the slots 37 under the hand nuts 35 (see FIG. 1) and fixed in place by tightening the hand nuts 35.

A feed-location adjuster is provided in order to enable the location at which the material is delivered to the spreader disk 22 (see FIG. 8) to be adjusted. The feed-location adjuster consists of a funnel 28 that can be pivoted about its vertical axis in a support 45. The support 45 has a flange 41 (see FIG. 2) with threaded bolts to which hand nuts 42 are screwed. When the support 45 is mounted, the threaded bolts pass through holes 43 (see FIG. 1) in the base frame 11 so that the support 45 (see FIG. 8) is fixed in place by tightening the hand nuts 42. It can be pivoted by means of an adjustment lever 29 such that the delivered material is optimally thrown by the thrower blades 27. The adjustment lever 29 can be fixed in place by means of a hand screw 40 in a slot 44 (see FIG. 1) of the base frame 11.

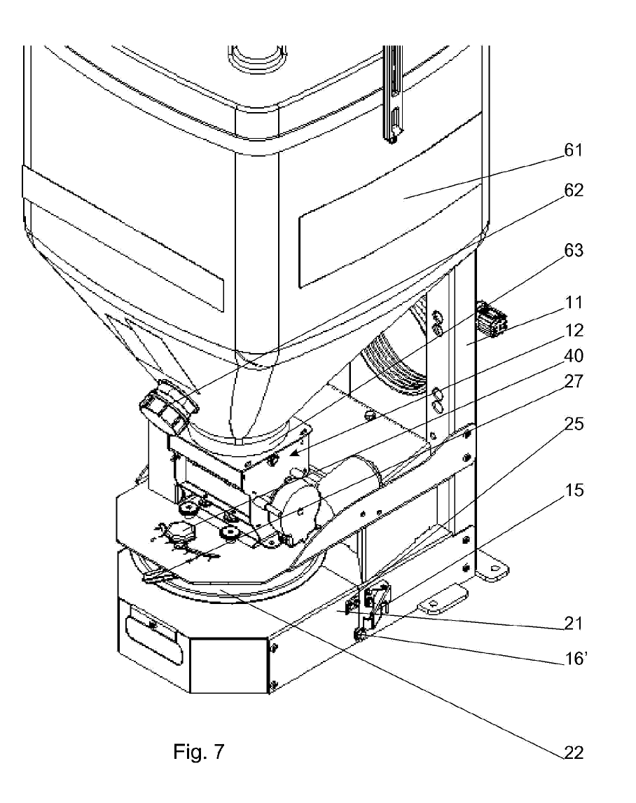

In addition to the quick-action fastener 15, the auxiliary frame 21 and the base frame 11 have openings 16 through which an axle 16′ (see FIGS. 2, 7, and 8) is inserted. After release by the quick-action fastener 15 (see FIG. 1), the auxiliary frame 21 (see FIG. 8) can thus be pivoted downward so that the funnel 28 is accessible. In this state, the conducted material can be collected and weighed very easily, so that the desired metered quantity (in kg/min or kg/h) can be set precisely in a simple manner by changing the speed of the gear motor 19. In order to remove the auxiliary frame 21, the axle 16 (see FIGS. 2, 7, and 8) must of course also be removed after disengagement of the quick-action fastener (see FIG. 1).

The elements for the disk spreader are easy to remove:

After disengagement of the quick-action fasteners 15 (and, optionally, after removal of the axles 16), the auxiliary frame 21 can be removed, and the collection hopper 23 and the feed-location adjuster can be removed after the loosening of a total of five hand nuts. In this state, distributors 32 and 32a such as those shown in FIGS. 3 and 4 can be connected to the metering unit 12 (see FIG. 1). For this purpose, the distributors 32 and 32a (see FIGS. 3 and 4) have on the upper opening 34 a flange 36 with slots 37 that corresponds exactly with the flange 36 (see FIG. 2) of the collection hopper 23. The distributors 32 and 32a (see FIGS. 3 and 4) can thus also be secured using the hand nuts 35 (see FIG. 1). There can be any number of outlets of the distributors 32 and 32a; for example, FIGS. 3 and 4 respectively show only six and two outlets.

The distributors 32 and 32a respectively divide the material passing through by the cell-wheel sluice 18 (see FIG. 8) into six and two partial flows in this example. Six or two hoses, depending on the number of partial flows, extend out from the respective distributors 32 and 32a (see FIGS. 3 and 4) and conduct the seed further along.

In order to enable calibration to be performed here, the distributors 32 and 32a can be opened in the middle by quick-action fasteners 38.

If desired, conveyance through the hose lines can be augmented by a blower 51 (see FIG. 5) that, as seen in FIGS. 3 and 4, is mounted behind the distributor 32 and 32a. The blower 51 can be screwed to the base frame 11 (see FIGS. 1, 5, and 10).

The following elements can thus be offered:
Disk spreader
Distributor for a partial flow without blower
Distributor for a partial flow with blower
Distributor for two partial flows without blower
Distributor for two partial flows with blower
Distributor for three partial flows without blower
Distributor for three partial flows with blower
Distributor for four partial flows without blower
Distributor for four partial flows with blower
Distributor for six partial flows without blower
Distributor for six partial flows with blower,
   and the customer selects the elements that are appropriate for him. If he requires at least one element in addition to the disk spreader, then this is already more economical for the customer than purchasing various devices.

1. A spreader comprising:
a base frame;
an auxiliary frame;
a container secured to the base frame;
a spreader disk secured beneath the container to the auxiliary frame;
a metering unit; having an outlet at the bottom;
a collection hopper provided on the base frame beneath the container hopper and secured to the outlet of the metering unit; and
a quick-action fastener securing the auxiliary frame to the base frame.

2. The spreader defined in claim 1, further comprising:
an axle pivoting the auxiliary frame on the base frame so that the auxiliary frame can be pivoted down and out of the way after release by the quick-action fastener.

3. The spreader defined in claim 1, further comprising:
a distributor connectable to the outlet of the metering unit upon removal of the auxiliary frame and collection hopper.

4. The spreader defined in claim 3, wherein the distributor is provided with a blower.
